(19) United States
(12) Patent Application Publication
(10) Pub. No.: US 2013/0223061 A1
(43) Pub. Date: Aug. 29, 2013

(54) MULTI-LAYER ARRAY TYPE LED DEVICE HAVING A MULTI-LAYER HEAT DISSIPATION STRUCTURE

(71) Applicants: JON-FWU HWU, Hsinchu (TW); Yung-Fu Wu, Hsinchu (TW); Kui-Chiang Liu, Hsinchu (TW)

(72) Inventors: JON-FWU HWU, Hsinchu (TW); Yung-Fu Wu, Hsinchu (TW); Kui-Chiang Liu, Hsinchu (TW)

(21) Appl. No.: 13/409,095

(22) Filed: Feb. 29, 2012

(51) Int. Cl. F21V 11/00; F21V 29/00

(52) U.S. Cl. 362/235; 362/294

(57) ABSTRACT

A multi-layer array type LED device having a multi-layer heat dissipation structure includes a heat dissipation seat, an optical module, a housing, a power supply module, a wireless transmission module, a diffusion cover and a lamp head. In the present invention, the heat-generating components include the optical module, the power supply module and the wireless transmission module, and the heat-generating components are separately installed so that the heat accumulation effect can be decreased. In the present invention, the heat dissipation seat is used together with the housing having a plurality of the heat dissipation holes. The heat dissipation seat having excellent heat conductivity is used for rapidly absorbing heat and transferring it to the surrounding environment, and the surrounding air can be introduced into the housing via the heat dissipation holes for further increasing the heat dissipation efficiency.

### BACKGROUND OF THE INVENTION

1. Field of the Invention

The present invention relates to an illumination device, and more particularly to a multi-layer array type LED device having a multi-layer heat dissipation structure which has an excellent heat dissipation performance.

2. The Prior Arts

With the breakthrough of light emitting diode (LED) technology, the illumination brightness and the illumination efficiency are greatly increased, and thereby LED gradually becomes the new illumination component for replacing conventional lamp bulb, and thereby LED is widely used in a vehicle illumination device, a hand-held illumination device, a backlight source for liquid crystal display device, a traffic sign lamp or an indication billboard.

FIG. 1 is a schematic view showing a structure of a conventional LED. As shown in FIG. 1, a conventional LED 1a includes at least one LED chip 11a, a substrate 12a and a package body 13a, wherein the LED chip 11a is disposed on the substrate 12a and connected with the substrate 12a. The package body 13a is used for packaging the LED chip 11a and the substrate 12a, and such a LED can emit certain color light. The LED 1a is driven and controlled by an external drive circuit 2a. The LED has to be connected to the substrate 3a of the external drive circuit 2a when it is operated. However, when the LED is driven and controlled by the external drive circuit, the heat generation becomes a problem. Therefore, the heat generation problem must be solved in order to increase the illumination efficiency. There were two different conventional methods for solving the issue of heat generation, and one method is based on an internal heat dissipation mechanism installed inside of the LED, and another method is based on an external auxiliary heat dissipation mechanism installed outside of the LED. In the internal heat dissipation mechanism of LED, a heat conductive unit is installed in the LED module for allowing heat generated by the LED chip to be transferred to the exterior of the LED module. In the external auxiliary heat dissipation mechanism, a heat dissipator or a fan is installed for dissipating heat generated by the LED chip.

The internal heat dissipation mechanism and/or the external auxiliary heat dissipation mechanism can be utilized by the conventional LEDs for dissipating heat generated by the LED chip, but these heat dissipation mechanisms have their limitations for dissipating heat so that the temperature of the LED module cannot be effectively lowered, which cause the decrease of the illumination efficiency of LED and the increase of the cost for heat dissipation. Furthermore, when the external heat dissipation mechanism is utilized by the LED for dissipating heat, the arrangements and the connection between the LED and the substrate of the external drive circuit will become an issue to be solved.

Accordingly, it is desirable to provide a new heat dissipation structure capable of solving the heat dissipation problems existing in the conventional LED module, and decreasing the operation temperature of the LED module.

### SUMMARY OF THE INVENTION

An objective of the present invention is to provide a multi-layer array tape LED device having a multi-layer heat dissipation structure, which comprises a heat dissipation seat, an optical module, a housing, a power supply module, a wireless transmission module, a diffusion cover and a lamp head.

In the present invention, the heat-generating components include the optical module, the power supply module and the wireless transmission module, wherein the optical module, the power supply module and the wireless transmission module are separately installed, and the heat dissipation seat is disposed between the optical module, and the power supply module and the wireless transmission module, wherein the heat dissipation seat is preferably made of a solid aluminum material having excellent heat conductivity, and thereby the heat generated by the optical module, the power supply module and the wireless transmission module can be effectively absorbed and transferred to the surrounding environment.

According to one embodiment of the present invention, the surface of the heat dissipation seat is coated with heat dissipation paste.

According to the present invention, the heat-generating components are separately installed so that the heat accumulation effect can be decreased. Furthermore, in the present invention, the heat dissipation seat is used together with the housing having a plurality of the heat dissipation holes. The heat dissipation seat having excellent heat conductivity is used for rapidly absorbing heat and transferring it to the surrounding environment, and the surrounding air can be introduced into the housing via the heat dissipation holes for further increasing the heat dissipation efficiency. Therefore, the service lives of the components of the multi-layer array type LED device can be prolonged, and the working performance of these components can be maintained for a long period of time.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing the structure of a conventional LED;

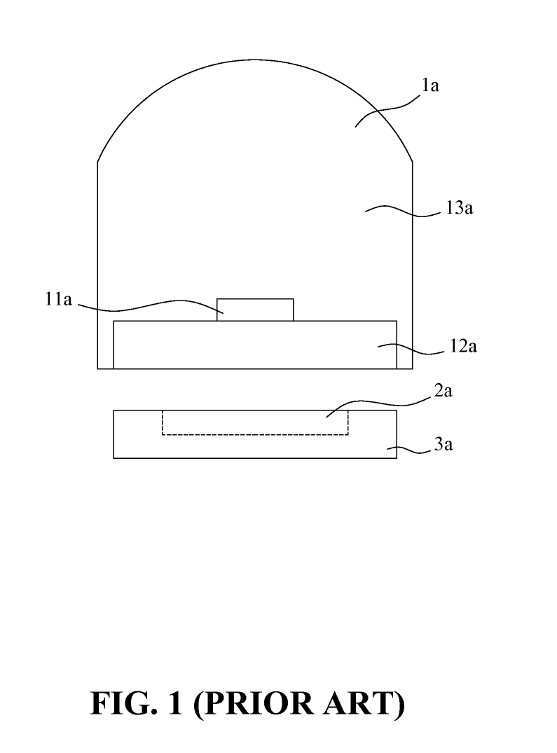

FIG. 2 is a schematic perspective view showing a multi-layer array type LED device having a multi-layer heat dissipation structure according to the present invention;

FIG. 3 is an exploded perspective view showing the multi-layer array type LED device having a multi-layer heat dissipation structure according to the present invention;

FIG. 4 is a schematic view showing a heat dissipation seat of the multi-layer array type LED device having a multi-layer heat dissipation structure according to the present invention;

FIG. 5 is a cross sectional view showing the multi-layer array type LED device having a multi-layer heat dissipation structure according to the present invention;

FIG. 6 is a schematic view showing the multi-layer array type LED device having a multi-layer heat dissipation structure according to one embodiment of the present invention;

FIG. 7 is a schematic perspective view illustrating a heat dissipation fins according to one embodiment of the present invention; and

FIG. 8 is a schematic view illustrating the heat dissipation seat engaged with the housing according to one embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

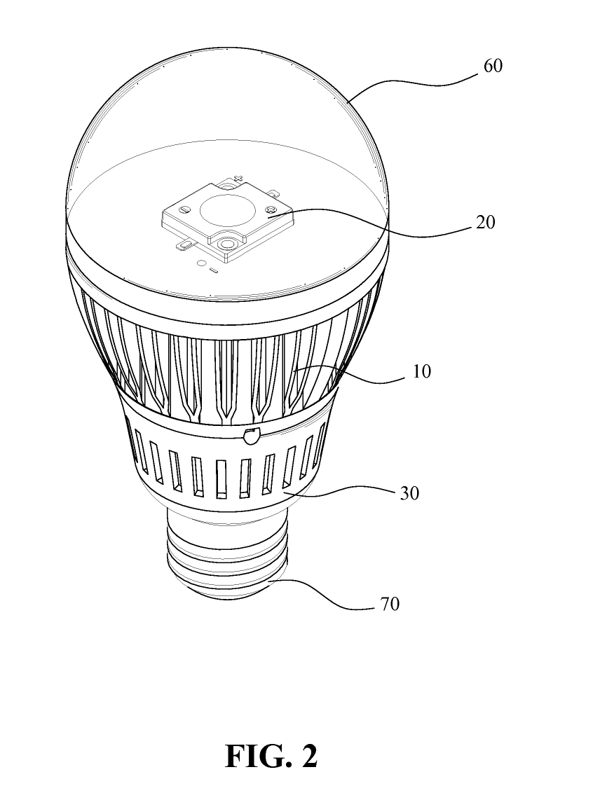

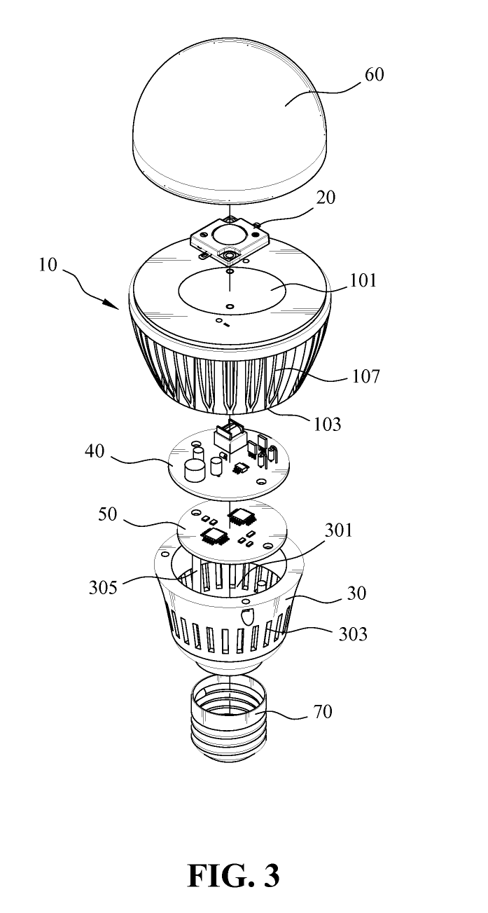

FIG. 2 is a schematic perspective view showing the multi-layer array type LED device having a multi-layer heat dissipation structure according to the present invention. FIG. 3 is an exploded perspective view showing the multi-layer array type LED device having a multi-layer heat dissipation structure according to the present invention. Please refer to FIGS. 2 and 3, the multi-layer array type LED device having a multi-layer heat dissipation structure of the present invention comprises a heat dissipation seat 10, an optical module 20, a housing 30, a power supply module 40, a wireless transmission module 50, a diffusion cover 60 and a lamp head 70.

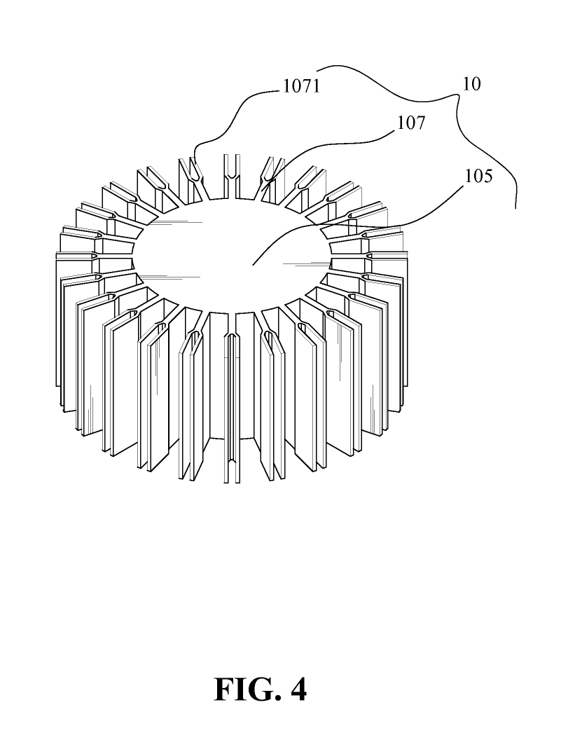

FIG. 4 is a schematic view showing the heat dissipation seat of the multi-layer array type LED device having a multi-layer heat dissipation structure according to the present invention. The heat dissipation seat 10 has a first surface 101 and a second surface 103 opposite to the first surface 101, wherein the heat dissipation seat 10 includes a cylinder 105 with a plurality of heat dissipation fins 107 spaced around the circumference of the cylinder 105, and the heat dissipation fins 107 are radially outwardly extended from the cylinder 105, and each heat dissipation fin 107 has a branched structure 1071 at its outer end, and thereby the heat dissipation area of the heat dissipation fin 107 is increased. The heat dissipation fins 107 are designed to have a corrugated shape such as wave-like or tooth-like shape. In comparison with the flat heat dissipation fins 10, the heat dissipation areas of the corrugated heat dissipation fins 107 are relatively larger, and thereby the heat dissipation efficiency of the heat dissipation seat 10 is greatly increased. Moreover, the heat dissipation seat 10 is made of a solid aluminum material.

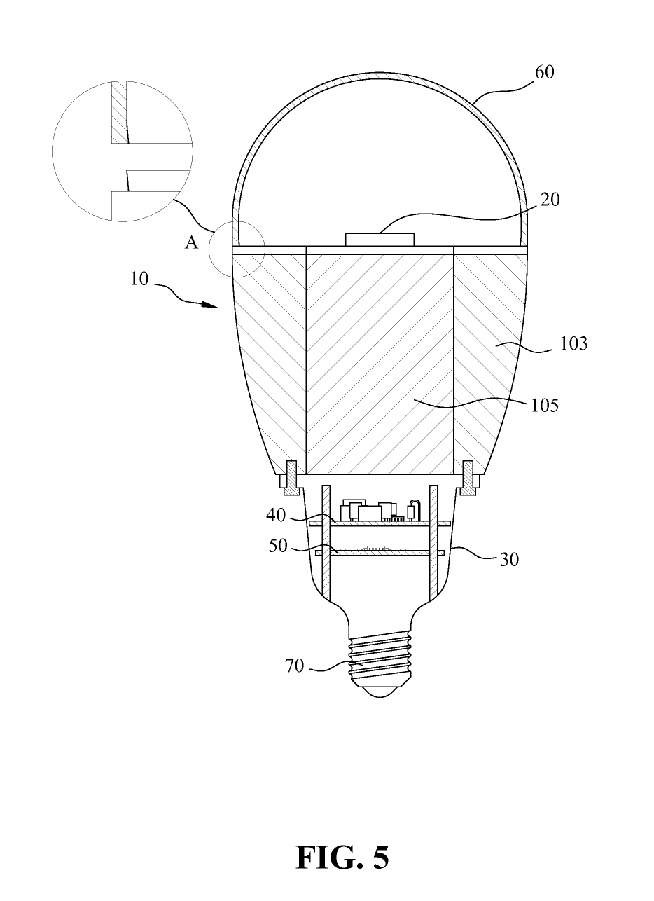

FIG. 5 is a cross sectional view showing the multi-layer array type LED device having a multi-layer heat dissipation structure according to the present invention. The optical module 20 is disposed on the first surface 101 of the heat dissipation seat 10, wherein the optical module 20 is preferably to be disposed at the center of the first surface 101 of the heat dissipation seat 10. The first surface 101 of the heat dissipation seat 10 can be coated with the heat dissipation paste (not shown in figures), and the heat dissipation paste is disposed between the optical module 20 and the first surface 101, so that the heat generated by the optical module 20 during operation can be directly absorbed by the heat dissipation paste, and then the heat is transferred to the heat dissipation seat 10, and then dissipated to the surrounding environment through the heat dissipation fins 107. The optical module 20 is, for example, an array type LED device.

The housing 30 is engaged and fastened to the second surface 103 of the heat dissipation seat 10 by using the screws 80, and an accommodation space 301 is formed by the circumferential wall of the housing 30, and the circumferential wall of the housing 30 has a plurality of heat dissipation holes 303 disposed therethrough.

Please refer to FIG. 3, the power supply module 40 is disposed in the accommodation space 301 and below the second surface 103, and the power supply module 40 at least includes an optical module drive circuit (not shown in figures) for driving the optical module 20. The wireless transmission module 50 is also disposed in the accommodation space 301 and below the second surface 103. The arrangement for the power supply module 40 and the wireless transmission module 50 can be shown as FIG. 3, in which the power supply module 40 is disposed between the heat dissipation seat 10 and the wireless transmission module 5, and however, it is just an example and the present invention is not restricted thereto.

The interior of the housing 30 is further installed with two supports 305 for fastening the power supply module 40 to the wireless transmission module 50. The housing 30 and the supports 305 are made of molded plastic. The wireless transmission module 50 includes a Bluetooth® transmission module or a standard IEEE 802.11 wireless transmission module, or includes both of the Bluetooth® transmission module and the standard IEEE 802.11 wireless transmission module or other suitable wireless transmission module 50. The diffusion cover 60 is engaged and fastened to the first surface 101 of the heat dissipation seat 10, wherein the diffusion cover 60 is engaged to the heat dissipation seat 10 or the annular component of the heat dissipation seat 10, as shown in the zone A of FIG. 5. The lamp head 70 is installed at the bottom of the housing 30, and fastened to a lamp seat (not shown in figures) with the screws so that the multi-layer array type LED device of the present invention can be connected to an electricity source.

According to the present invention, the heat-generating components include the optical module 20, the power supply module 40 and the wireless transmission module 50, wherein the optical module 20 is disposed on the first surface 101 of the heat dissipation seat 10, and the heat generated by the optical module 20 during operation can be directly absorbed by the heat dissipation paste, and then the heat is transferred to the heat dissipation seat 10, and then rapidly dissipated to the surrounding environment through the heat dissipation fins 107 having a large heat dissipation area.

The power supply module 40 and the wireless transmission module 50 are disposed below the second surface 103, which is opposite to the first surface 101, of the heat dissipation seat 10. Heat generated by the power supply module 40 and the wireless transmission module 50 can be directly dissipated to the surrounding environment through the heat dissipation holes 303, and the second surface 103 of the heat dissipation seat 10 can be also used for absorbing and dissipating heat generated by the power supply module 40 and the wireless transmission module 50.

According to the present invention, the heat-generating components are separately installed so that the heat accumulation effect can be decreased. Furthermore, in the present invention, the heat dissipation seat is used together with the housing having a plurality of the heat dissipation holes. The heat dissipation seat having excellent heat conductivity is used for rapidly absorbing heat and transferring it to the surrounding environment, and also the surrounding air can be introduced into the housing via the heat dissipation holes for further increasing the heat dissipation efficiency. Therefore, the service lives of the components of the multi-layer array type LED device can be prolonged, and the working performance of these components can be maintained for a long period of time.

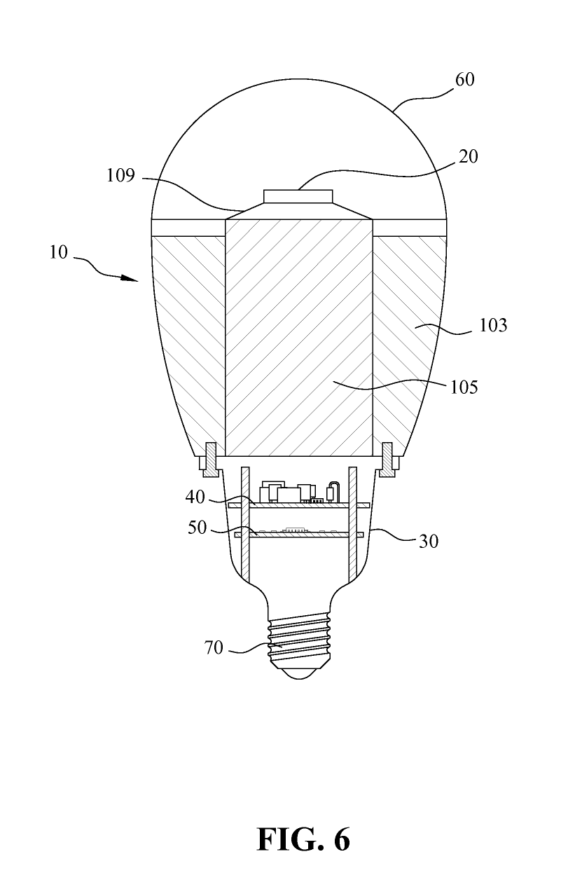

FIG. 6 is a schematic view illustrating the multi-layer array type LED device having a multi-layer heat dissipation structure according to one embodiment of the present invention. The multi-layer array type LED device of the present invention can further includes a seat 109 disposed on the first surface 101 of the heat dissipation seat 10, and the optical module 20 is disposed on the seat 109, wherein the seat 109 has an inclined lateral wall through which the light-emitting angle of the optical module 20 can be enlarged. The seat 109 can be integrally formed with the heat dissipation seat 10.

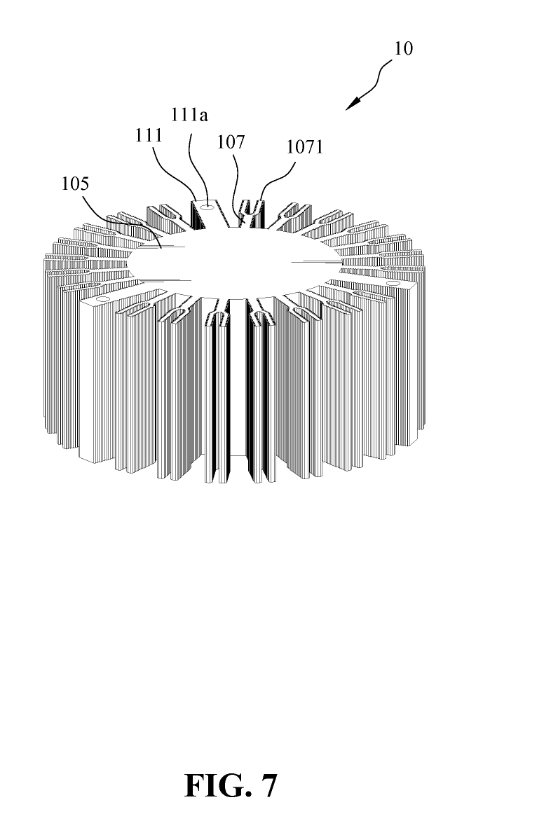

FIG. 7 is a schematic perspective view illustrating the heat dissipation fins according to one embodiment of the present invention. The heat dissipation seat 10 further includes a plurality of fixing plates 111 which are interposed between the heat dissipation fins 107, wherein the fixing plates 111 each has a fixing hole 111a, and a screw 80 can be inserted into the fixing hole to allow the heat dissipation seat 10 to be tightly engaged with the housing 30.

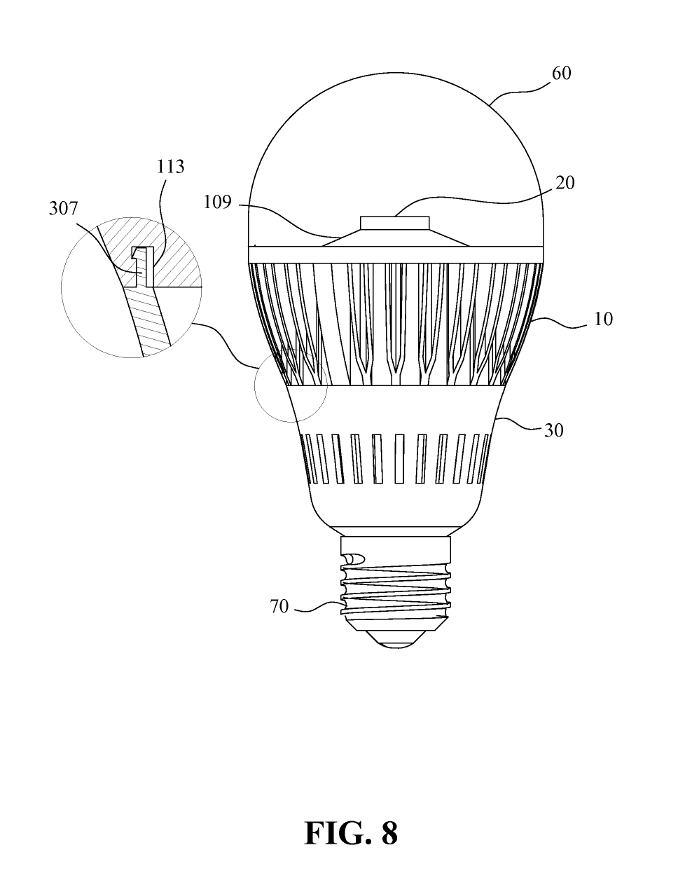

FIG. 8 is a schematic view illustrating the heat dissipation seat engaged with the housing according to one embodiment of the present invention. As shown in FIG. 8, the housing 30 and the heat dissipation seat 10 are respectively installed with a hook 307 and a corresponding groove 113, and the heat dissipation seat 10 is engaged and fastened to the housing 30 when the hook 307 is engaged in its corresponding groove 113.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A multi-layer array type LED device having a multi-layer heat dissipation structure, comprising:
a heat dissipation seat, having a first surface and a second surface opposite to the first surface;
an optical module, disposed on the first surface of the heat dissipation seat;
a housing, engaged and fastened to the second surface of the heat dissipation seat, an accommodation space being formed by a circumferential wall of the housing, the circumferential wall of the housing including a plurality of heat dissipation holes disposed therethrough;
a power supply module, disposed in the accommodation space and below the second surface, the power supply module including an optical module drive circuit;
a wireless transmission module, disposed in the accommodation space and below the second surface; and
a diffusion cover, engaged and fastened to the first surface of the heat dissipation seat.

2. The multi-layer array type LED device according to claim 1, wherein the heat dissipation seat includes a cylinder with a plurality of heat dissipation fins spaced around the circumference of the cylinder, and the heat dissipation fins are radially outwardly extended from the cylinder, and each heat dissipation fin has a branched structure at its outer end.

3. The multi-layer array type LED device according to claim 1, wherein the heat dissipation seat is made of a solid aluminum material.

4. The multi-layer array type LED device according to claim 1, further comprising a heat dissipation paste coated on the first surface.

5. The multi-layer array type LED device according to claim 1, wherein the optical module is an array type LED device.

6. The multi-layer array type LED device according to claim 1, wherein the optical module is disposed at the center of the first surface.

7. The multi-layer array type LED device according to claim 1, wherein the interior of the housing is installed with two supports for respectively fastening the power supply module and the wireless transmission module.

8. The multi-layer array type LED device according to claim 1, wherein the housing is made of molded plastic.

9. The multi-layer array type LED device according to claim 7, wherein the two supports are made of molded plastic.

10. The multi-layer array type LED device according to claim 1, wherein the wireless transmission module includes at least one of a Bluetooth® transmission module and a standard IEEE 802.11 wireless transmission module.

11. The multi-layer array type LED device according to claim 1, further comprising a seat disposed on the first surface of the heat dissipation seat, wherein the optical module is disposed on the seat, and the seat has an inclined lateral wall, and the seat is integrally formed with the heat dissipation seat.

12. The multi-layer array type LED device according to claim 1, wherein the heat dissipation seat further includes a plurality of fixing plates interposed between the heat dissipation fins, wherein the fixing plates each has a fixing hole, and a screw is inserted into the fixing hole to allow the heat dissipation seat to be tightly engaged with the housing.

13. The multi-layer array type LED device according to claim 1, wherein the housing and the heat dissipation seat are respectively installed with a hook and a corresponding groove, and the hook is engaged in the corresponding groove.
